(19) United States
(12) Patent Application Publication
(10) Pub. No.: US 2013/0151877 A1
(43) Pub. Date: Jun. 13, 2013

(54) SYSTEMS AND METHODS FOR PREDICTIVE CONTROL OF POWER EFFICIENCY

(71) Applicants: Rachid M. Kadri, Houston, TX (US); Reza M. Bacchus, Spring, TX (US)

(72) Inventors: Rachid M. Kadri, Houston, TX (US); Reza M. Bacchus, Spring, TX (US)

(21) Appl. No.: 13/817,852

(22) PCT Filed: Oct. 19, 2010
(86) PCT No.: PCT/US10/53161

§ 371 Date: Feb. 20, 2013

(51) Int. Cl. G06F 1/32

(52) U.S. Cl. CPC G06F 1/3296; G06F 1/3275
USPC 713/320

(57) ABSTRACT

A computer power management system (10) can include power demand logic (20) of a computer component (12) that can generate a power demand signal corresponding to a predicted power demand determined for the computer component (12). A voltage regulator down (VRD) system (14) includes at least one power phase (18). The VRD system (14) can selectively adjust an input power to the computer component (12) based on power efficiency in response to the power demand signal.

### BACKGROUND

The introduction of multi-core sockets integrating a higher number of memory channels and central processing unit (CPU) cores than in traditional CPUs is driving a need to operate servers at an efficient point for power savings. As servers are configured with an increasing memory capacity for Internet and/or software virtualization applications, customers are demanding improvement in power efficiency that can translates into costs savings.

### BRIEF DESCRIPTION OF THE DRAWINGS

FIG. 1 illustrates an example of a power management system.

FIG. 2 illustrates an example of a computer component in a power management system.

FIG. 3 illustrates an example of a graph of voltage over time for a power management system.

FIG. 4 illustrates another example of a power management system

FIG. 5 illustrates an example of a method for controlling power efficiency in a computer system.

### DETAILED DESCRIPTION

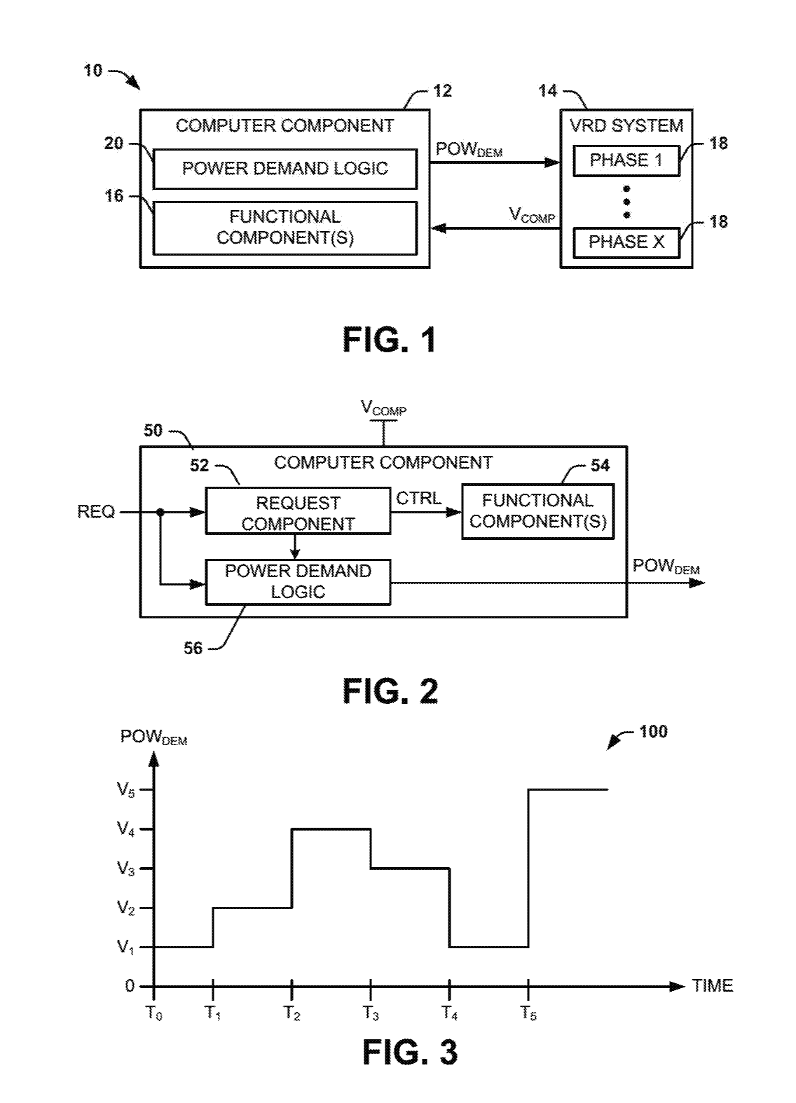

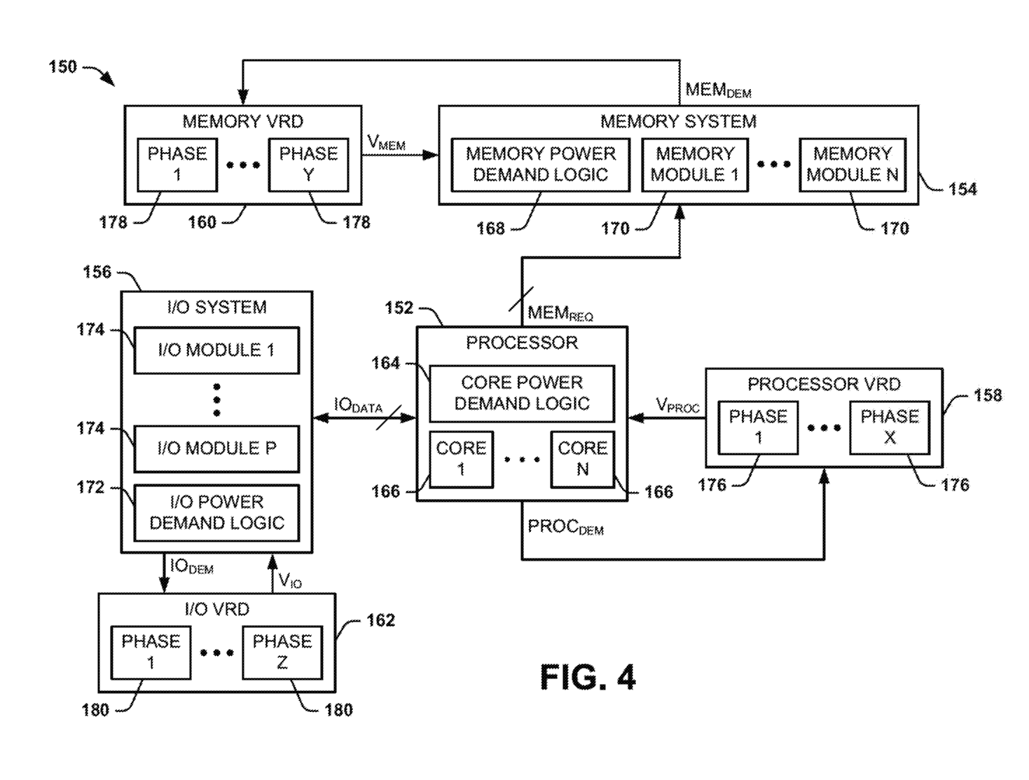

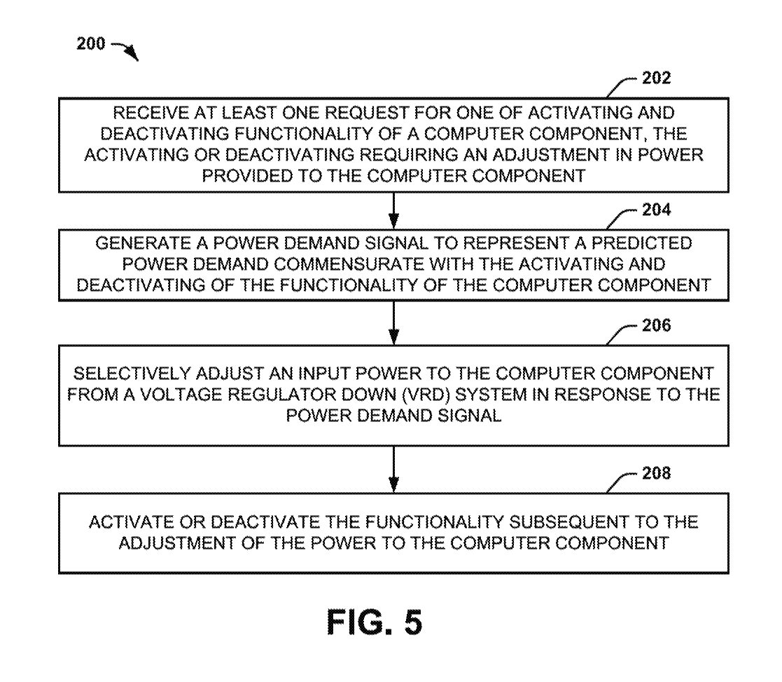

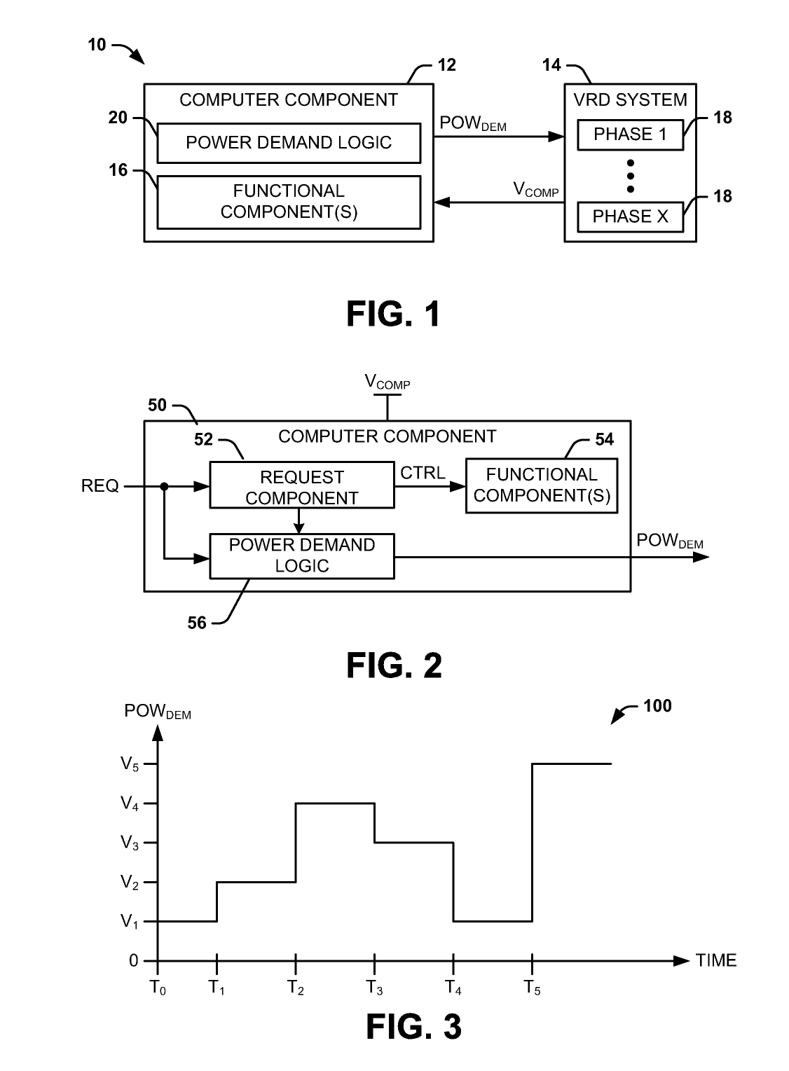

FIG. 1 illustrates an example of a power management system 10. The power management system 10 can be implemented in a variety of computer systems, such as in a personal computer or a server system. The power management system 10 includes or can include one or more computer components 12 that are provided power from a voltage regulator down (VRD) system 14. As an example, the computer component 12 can be any of a variety of electronic components in the associated computer system, such as a multi-core processor, a memory system, and/or an input/output (I/O) system. The VRD system 14 is configured to generate a voltage V_{COMP} to power the computer component 12 in an efficient manner, which can be optimized for a given application. Where there are more than one computer components 12, each component can have a dedicated VRD. For instance, a core VRD can provide core power, a memory VRD can provide memory power and an I/O VRD can provide I/O power.

In the example of FIG. 1, the computer component 12 includes one or more functional components 16 that can be selectively activated and deactivated according to operating requirements. For example, if the computer component 12 is a processor, the functional component(s) 16 can include one or more processor cores. If the computer component 12 is a memory system, the functional component(s) 16 can include one or more memory controllers and/or memory modules, such as dual inline memory modules (DIMMs). If the computer component 12 is an I/O system, the functional component(s) 16 can include one or more I/O modules or embedded function integrated circuits (ICs).

During operation of the associated computer system, the computer component 12 can include controls configured to selectively activate and deactivate the functional component(s) 16. For instance, the activation and deactivation of the functional component(s) 16 can vary based on the current operational status of the computer system.

By way of example, for situation where the computer component 12 is configured as a processor, such that the functional component(s) 16 are processor cores, the computer component 12 may be configured to switch one or more of the processor cores from an idle mode to an active mode during increased processing operations. Similarly, where the computer component 12 is configured as a memory system, such that the functional component(s) 16 are memory modules, the computer component 12 can include controls configured to activate one or more memory channels and memory modules, depending on the application, such as to store large amounts of data. Additionally, where the computer component 12 is configured as an I/O system, such that the functional component(s) 16 are I/O modules, the computer component 12 can include controls configured to activate one or more of the I/O modules to implement specific functions of the associated computer system. Additionally or alternatively, the functional component(s) can correspond to embedded functionality of the computer component 12 that affects the power demand of the computer component 12. That is, the functional component(s) 16 are not limited to separate subcomponents of the computer component 12 that can be selectively activated; deactivated as mentioned in the preceding example. Regardless of how the functional component(s) is implemented, the power demand of the computer component 12 can change significantly over a given span of operating time.

In the example of FIG. 1, the VRD system 14 includes a plurality of power phases 18, depicted as being numbered from 1 to X, where X is a positive integer that is greater than one denoting the number of power phases. The plurality of power phases 18 can be configured as separate power converters, such as switching regulators. During startup of the associated computer system, the VRD system 14 can be configured to enable a number of the power phases 18. The number of power phases can be predetermined or can vary based on the configuration of the computer component 12 at startup.

Additionally, the VRD system 14 can be configured to selectively enable and disable the power phases 18 based on the power demand of the computer component 12 during operation of the computer component 12. Thus, the VRD system 14 can dynamically respond to the power demands of the computer component 12. As a result, the VRD system 14 can provide power efficiently in manner based on the power demand of the computer component 12. As described herein, an efficient manner can correspond to providing an output current associated with the voltage V_{COMP}, which depends on the number of power phases 18 that are enabled by the VRD system 14, to provide a high efficiency within defined operating parameters.

In the example of FIG. 1, the computer component 12 includes power demand logic 20. The power demand logic 20 can be configured to provide a signal POW_{DEM} to the VRD system 14. The signal POW_{DEM} can be generated with a measurable characteristic that is indicative of the power demand of the computer component 12, such as corresponding to the selective activation/deactivation of the functional component(s) 16. Therefore, the VRD system 14 can be configured to selectively enable and disable each of power phases 18 as to generate the magnitude of the associated current that efficiently provides power to the computer component 12.

As a further example, to help conserve space and available pins between circuit packages that comprise the computer component 12 and/or the VRD system 4, the signal POW_{DEM} can be communicated over a single conductor. As an example, the signal POW_{DEM} can be an analog voltage signal having a magnitude that corresponds to the number of power phases 18 to be selectively enabled by the VRD system 14. As another example, the signal POW_{DEM} can be a single conductor digital signal, such as a pulse-width modulated signal having a duty-cycle that corresponds to the number of power phases 18 to be selectively enabled by the VRD system 14. However, the signal POW_{DEM} can be configured as other types of signals instead. For example, the signal POW_{DEM} can be configured as a set of interrupt signals, a combination of signals reflecting different power states, or one or more voltage identification digital (VID) signals.

As described herein, to provide power efficiently to the computer component 12 based on the power demand of the computer component 12, the VRD system 14 can dynamically enable and disable the power phases 18, and thus dynamically adjust the magnitude of the current associated with the voltage V_{COMP}, in a predictive manner. The VRD system 14 can adjust the magnitude of the current associated with the voltage V_{COMP} to meet the power demand before the functional component(s) 16 that necessitate the change in power demand are activated or deactivated. For instance, controls in the computer component 12 can anticipate a change in activation (or deactivation) of the functional component(s) for a predetermined time from when the (POW_{DEM}) signal is provided to the VRD system 14. This delay can be small enough as to not impact the overall performance of the associated computer system to allow sufficient time for the VRD system to enable and/or disable one or more phases according to the signal POW_{DEM}.

By way of further example, the power demand logic can employ a look-up table or other structure (e.g., hardware look table or other logic structure) that is configured to determine a value of the power demand signal POW_{DEM}. The value of the power demand signal POW_{DEM} can thus be used to control the VRD system 14 to change the power delivery based on the change to the associated current corresponding to the voltage V_{COMP}, which that can efficiently power the computer component in response to amount of functional components (e.g., functionality) being requested. For instance, the look-up table can be programmed with a plurality of values for the power demand signal POW_{DEM} according to system design and application requirements. Each value of the signal POW_{DEM} can be used to activate a predetermined number of power phases designed to power the computer component 12 at or above a predetermined efficiency level.

In this way, the VRD system 14 can provide power efficiently to the computer component 12 with substantially no voltage droop of the voltage V_{COMP}. Accordingly, the power management system 10 can substantially mitigate the chance of a fault that could shut down one or more of the power phases 18 in response to temporarily not being able to meet the power demand, such as based on adjusting the power delivery in a reactive manner, as opposed to the predictive manner described herein. Such delay can be fixed or it may vary according to application design requirements. In addition, the predictive adjustment to power delivery can be performed in real time so as to not affect performance of the associated computer system.

FIG. 2 illustrates an example of a computer component 50 in a power management system. The power management system can be the power management system 10, and the computer component 50 can correspond to the computer component 12 in the example of FIG. 1. Therefore, reference can be made to the example of FIG. 1 in the following description of the example of FIG. 2 for additional context.

The computer component 50 includes a request component 52. The request component 52 can be configured to selectively activate and deactivate one or more functional components 54, similar to as described above in the example of FIG. 1, in response to one or more request signals REQ. Thus, the request signal(s) REQ can correspond to requests to selectively activate and/or deactivate the functional component(s) 54 based on operation of the associated computer system. In the example of FIG. 2, the request signal(s) REQ are demonstrated as being provided from a source external to the computer component 52. However, as an example, the request signal(s) REQ could instead be generated internal to the computer component 52. As another example, the requests to selectively activate and/or deactivate the functional component(s) 54 could instead be generated directly by the request component 52.

As mentioned above, for example, the functional component(s) 54 can be a plurality of core processors, a plurality of memory controllers and associated memory modules, or a plurality of I/O modules in the example of the computer component 50 being configured as a processor, a memory system, or an I/O system, respectively. The request component 52 can be configured as any of a variety of circuits, such as a memory queue configured to queue activation and/or deactivation of the functional component(s) 54, a processor task dispatcher configured to selectively enable one or more processor cores, or a controller (e.g., an I/O controller) configured to activate and/or deactivate the functional component(s) 54. The request component 52 can thus generate a respective one or more control signals CTRL in response to the request signal(s) REQ to selectively activate or deactivate of the functional component(s) 54 in accordance with the request signal(s) REQ. For the example where the computer component 50 is a memory system, the control signal CTRL can be provided in response to a request to activate one or more chip select (CS) signals (e.g., based on the request signal(s) REQ), such that each of the CS signals corresponds to activation of a respective DIMM.

In the example of FIG. 2, the request component 52 includes power demand logic 56. The power demand logic 56 can comprise a set of logic gates or other logic functions (e.g., hardware) residing in the request component 52, such that the power demand logic 56 can likewise receive the one or more request signals REQ as inputs. The power demand logic 56 can thus monitor the request signal(s) REQ to determine whether to change the value of the signal POW_{DEM} due to impending activation or deactivation of the functional component(s) 54. The power demand logic 56 thus can be configured to generate the signal POW_{DEM} to indicate the power demand of the computer component 50 in response to receiving the request signal(s) REQ. The power demand indicated by the signal POW_{DEM} can represent a total power demand or an incremental increase or decrease in power demand. As a result, an associated VRD system, such as the VRD system 14 in the example of FIG. 1, can activate or deactivate an appropriate number of the power phases 18 that powers the computer component 50 based on the anticipated power demand, as indicated by the signal POW_{DEM}.

As an example, the request signal(s) REQ can simply be configured as an early indication of further activation of one or more functional components 54. As an example, the power demand logic 56 can be configured to generate the signal POW_{DEM}, such that the relative timing between the generation of the signal POW_{DEM} and the control signal(s) CTRL can be carefully controlled by the power demand logic 56. However, while the example of FIG. 2 demonstrates that the power demand logic 56 generates the signal POW_{DEM} based on the request signal(s) REQ, the power demand logic 56 could instead generate the signal POW_{DEM} based on one or more signals provided from the request component 52 or from the functional component(s) 54 themselves, such as in response to a request for activation or deactivation. Thus, the power demand logic 56 generates the signal POW_{DEM} in a predictive manner, and not in reaction to the activation or deactivation of the functional component(s) 54.

The power demand logic 56 thus allows rapid adjustments to switching a number of the power phases 18 for the power provided to the computer component 50, while still allowing fast operation of the associated computer system without compromising performance. For instance, by implementing the power demand logic 56 as gate logic, such as within the request component 52, the power demand logic 56 provides a hardware solution for adjustment to the new power demand in terms of increased current delivered by activating one or more power phases 18 when one or more functional components 54 are activated, which can function with greater speed when compared to a software solution. Because of the fast changes in activation and deactivation of functional components 54, a software solution would operate in a significantly slower manner to achieve the same results and therefore would greatly affect the overall system performance. Furthermore, if the value of signal POW_{DEM} was the result of a software function, the transient current demand from computer components 50 would be significantly slow to respond, resulting in disabling faults of the associated VRD system. Accordingly, the power demand logic 56 in the example of FIG. 2 provides an efficient solution to providing adjustment to the transient currents to the computer component 50 in a rapid and efficient manner.

It is to be understood that the power management system 10 and the computer component 50 are not limited to the examples of FIGS. 1 and 2, respectively. For instance, the power management system 10 and the computer component 50 are demonstrated simplistically, such that additional components may have been omitted for the sake of simplicity. In addition, the VRD system 14 can be configured to regulate the voltage V_{COMP} in other ways than just selectively enabling and disabling the power phases 18. As an example, if the VRD system 14 is configured as a single phase 18 only, then signal POW_{DEM} could be used by the VRD system 14 to alter a switching duty-cycle of the respective power phase 18. Furthermore, the request component 52 may be configured separately from the computer component 50. As an example, the computer component 50 can be configured as a memory system, such that the request component 52 can be configured as a memory controller within a processor at different location on a motherboard of the associated computer system.

FIG. 3 illustrates an example of a graph 100 of voltage over time for a power management system, such as the power management system 10 in the example of FIG. 1. Therefore, reference may be made to the examples of FIGS. 1 and 2 in the following description of the example of FIG. 3. The voltage demonstrated in the graph 100 is the signal POW_{DEM}, and is thus demonstrated in the example of FIG. 3 as a multi-level analog signal, such as provided to the VRD system 14 in the example of FIG. 1. The voltage is demonstrated as ranging in magnitude in discrete levels from V₁ to V₅. Each of the voltages V₁ to V₅ can correspond to an increase of activation of the power phases 18 of the VRD system 14. As an example, each of the voltages V₁ to V$ can be configured to change in 250 mV steps, where each step can correspond to an incremental activation of a power phase 18.

At a time T₀, the voltage POW_{DEM} has a magnitude of V₁, such that a single one of the power phases 18 can be enabled to generate the required current for the voltage POW_{DEM}. At a time T₁, the voltage POW_{DEM} increases to V₂. As an example, the increase in the magnitude of the voltage POW_{DEM} can be as a result of one or more additional functional components 54 being activated. At a time T₂, the voltage POW_{DEM} increases in magnitude from V₂ to V₄. Similar to as described above, the increase in the magnitude of the voltage POW_{DEM} can be a result of a request of activation of one or more additional functional components 54. However, because the power management system 10 manages power in a predictive manner, the VRD system 14 can enable multiple power phases (e.g., two at the time T₂) at one time in response to anticipated large increases in the power demand as indicated by the signal POW_{DEM}. Thus, the voltage V_{COMP} does not experience voltage droop and the VRD system 14 can adjust dynamically for increased power demand for powering the computer component 50 efficiently.

At times T₃ and T₄, the voltage POW_{DEM} decreases from V₄ to V₃ and from V₃ to V₁, respectively. As an example, the decrease in the magnitude of the voltage V_{COMP} can be as a result of one or more additional functional components 54 being requested to deactivate. Similar to as described above, the predictive manner in which the VRD system 14 manages power can result in one or more power phases disabled at one time in response to anticipated (e.g., prior to) large decreases in the power demand indicated by the signal POW_{DEM} to keep the power efficiency within desired operating parameters depending on the overall efficiency curve (e.g., the number of power phases 18 activated versus the current delivery) of the design of the VRD system 14.

At a time T₅, the voltage POW_{DEM} increases from V₃ to V₅. Such increase could result from the control signal(s) CTRL requesting activation of some or all of the functional component(s) 54. As an example, at the time T₅, the functional component(s) 54, such as processor cores, memory controllers, memory modules, and/or I/O controllers, could have all been in an idle or deactivated state. Thus, the control signal(s) CTRL can request that some or all of the functional component(s) 54 be activated substantially concurrently. Therefore, the power demand logic 56 can predict the maximum power demand of the computer component 50 based on the control signal(s) CTRL, such that the magnitude of signal POW_{DEM} can be adjusted to a maximum available measurable characteristic. In response to such power demand being indicated by the signal POW_{DEM}, the VRD system 14 can enable all of the power phases 18 to provide a maximum output power.

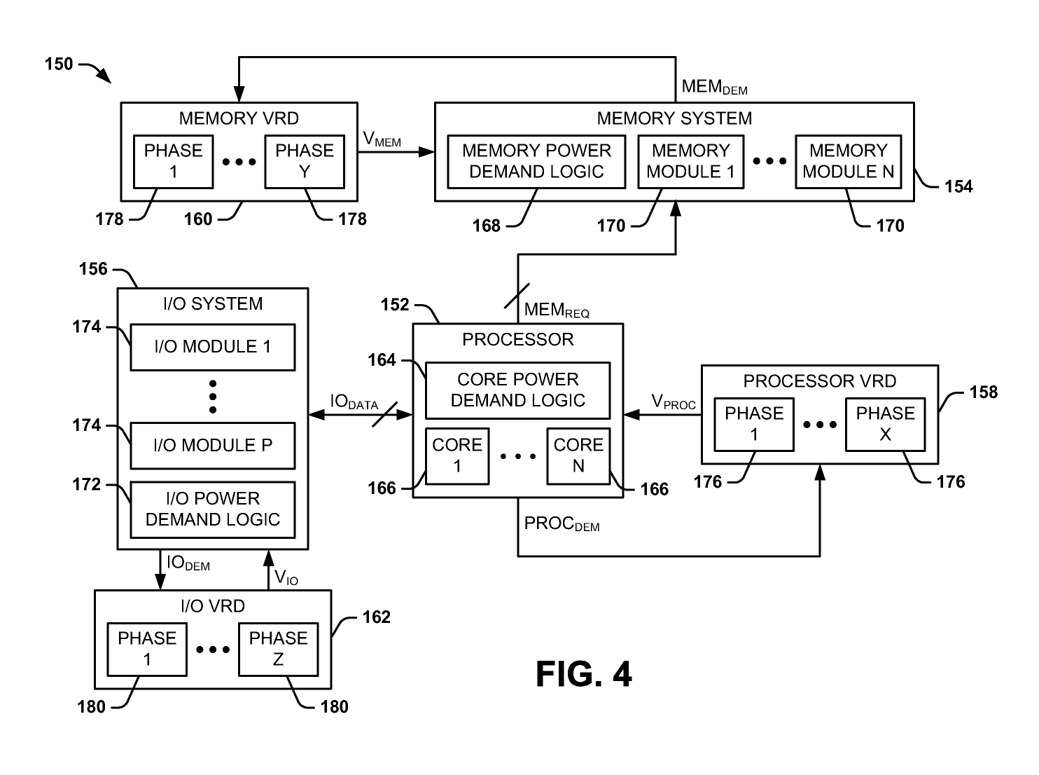

FIG. 4 illustrates another example of a power management system 150. The power management system 150 can be implemented in a variety of computer systems, such as in a personal computer or a server system. The power management system 150 includes one or more processors 152, a memory system 154, and an I/O system 156. Each of the processor 152, memory system 154, and I/O system 156 can correspond to separate computer components, similar to the computer components 12 and 50 shown and described in the examples of FIGS. 1 and 2. The power management system 150 also includes a processor VRD system 158, a memory VRD system 160, and an I/O VRD system 162, each of which individually or in any combination can be referred to as a VRD system. Each of the processor, memory, and I/O VRD systems 158, 160, and 162 is configured to generate voltages V_{PROC}, V_{MEM}, and V_{IO} to power the respective computer components, namely, processor 152, memory system 154, and I/O system 156 in an efficient manner.

In the example of FIG. 4, the processor 152 includes core power demand logic 164 and a plurality N of processor cores 166, where N is a positive integer denoting the number of cores. The processor 152 is configured to dynamically control activation and deactivation of the cores 166, such as via a processor task dispatcher (not shown). As an example, a task scheduler (not shown) associated with the processor 152 may be configured to identify when a task is completed and to which of the cores 166 the task is assigned. As another example, as new tasks are being scheduled, the task scheduler, prior to starting a new task, may update a status bit table reflecting activity of the cores 166. Thus, the processor 152 can switch the cores 166 between an idle mode and an active mode based on the activity of the associated computer system. As an example, the processor 152 can set the cores 166 to the idle or active mode based on control signals (not shown).

The memory system 154 includes memory power demand logic 168 and a plurality M of memory modules 170 in the memory system 154, such as DIMMs. The processor 152 can be configured to control activation and deactivation of the memory modules 170. For example, when the processor 152 requires access to one or more of the memory modules 170, the processor 152 can generate request signals MEM_{REQ} that request activation of one or more select memory modules 170 according to the memory channels being accessed. As an example, the request signals MEM_{REQ} can be queued in one or more memory controllers (not shown), such that one or more chip select signals are generated to control activation of the memory modules 170 in response to activation requests in the respective queue. Alternatively, the memory controller(s) can be arranged as part of the processor system 152, such that the processor 152 generates the chip select signals to the memory system 154. Thus, the chip select signals provided from the processor system 152 could be delayed relative to the request signals MEM_{REQ}, as also provided from the processor system 152. In this way, the memory power demand logic 168 can predictively control V_{MEM} in anticipation of changes in the number of active memory modules.

In a similar arrangement, the I/O system 156 can include I/O power demand logic 172 and a plurality P of I/O modules 174, where P is a positive integer denoting the number of I/O modules. For example, the I/O modules 174 can be configured as one or more of embedded function ICs and/or I/O cards, such as peripheral component interconnect (PCI) cards. As an example, the processor 152 can communicate with the I/O system 156 via a bus according to a set of signals demonstrated as IO_{DATA}. The signals IO_{DATA} can include control signals configured to request activity associated with one or more of the I/O modules 174. Thus, the I/O system 156 can selectively activate and deactivate the I/O modules 174 in response to the signals IO_{DATA}, such as based on the operation of an I/O controller (not shown).

In the example of FIG. 4, the processor VRD 158 includes a plurality X of power phases 176, the memory VRD 160 includes a plurality Y of power phases 178, and the I/O VRD 162 includes a plurality Z of power phases 180, where X, Y, and Z are positive integers denoting the number of phases in each VRD system. During startup of the associated computer system, the VRD systems 158, 160, and 162 can be configured to enable a number of the respective power phases 176, 178, and 180 that are necessary to power the processor 152, memory system 154, and I/O system 156, respectively, based on their respective statuses at startup. As an example, one or more of each of the memory modules 170 and I/O modules 174 may not be populated into respective sockets in the memory system 154 and the I/O system 156, respectively. Thus, the memory VRD system 160 and the I/O VRD system 162 may disable one or more unnecessary power phases 178 and 180, respectively, according to the initial system configuration.

In addition, the VRD systems 158, 160, and 162 can be configured to selectively enable and disable the respective power phases 176, 178, and 180 based on the power demands of the respective processor 152, memory system 154, and I/O system 156 during run time. Thus, the VRD systems 158, 160, and 162 can dynamically respond to transient current demands from the respective processor 152, memory system 154, and I/O system 156 in an efficient manner based on the respective power demands.

As an example, the core power demand logic 164, the memory power demand logic 168, and the I/O power demand logic 172 can be configured to generate respective power demand signals, demonstrated in the example of FIG. 4 as PROC_{DEM}, MEM_{DEM}, and IO_{DEM}. As an example, the processor 152, the memory system 154, and/or the I/O system 156 could include a table or a queue that is implemented as part of a combinatorial circuit to drive an Analog-to-Digital (A/D) converter to output an appropriate magnitude of the respective power demand signals PROC_{DEM}, MEM_{DEM}, and IO_{DEM} prior to activating and/or deactivating the respective one or more cores 166, memory modules 170, and I/O modules 174. The power demand signals PROC_{DEM}, MEM_{DEM}, and IO_{DEM} can each be provided over single conductor analog or digital signals, which signals can have a measurable characteristic (e.g., magnitude or duty-cycle or value) that represents the power demands of the respective processor 152, memory system 154, and I/O system 156. Therefore, the VRD systems 158, 160, and 162 can adjust in a real time manner to transient current demands for V_{PROC}, V_{MEM}, and V_{IO} to the respective processor 152, memory system 154, and I/O system 156 based on the respective power demands indicated by the power demand signals PROC_{DEM}, MEM_{DEM}, and IO_{DEM}.

In addition, to provide power efficiently to the respective processor 152, memory system 154, and I/O system 156 based on their respective power demands, the VRD systems 158, 160, and 162 can dynamically enable and disable the power phases 176, 178, and 180, to respond to transient current demands in a predictive and efficient manner, such as described above in the example of FIG. 2. Accordingly, the power management system 150 can substantially mitigate voltage droop of the voltages V_{PROC}, V_{MEM}, and V_{IO}, and thus the chance of a fault that could shut down one or more of the power phases 176, 178, and 180 in response to temporarily not being able to meet the power demand.

It is to be understood that the power management system 150 is not intended to be limited to the example of FIG. 4. As an example, the power management system 150 need not include the dynamic power management, as described herein, for all three of the processor 152, the memory system 154, and the I/O system 156. As another example, the power management system 150 can include additional computer components and respective additional VRD systems, such that the power management methodology described herein can be applied to any combination of one or more computer components. Thus, the power management system 150 can, be configured in a variety of ways.

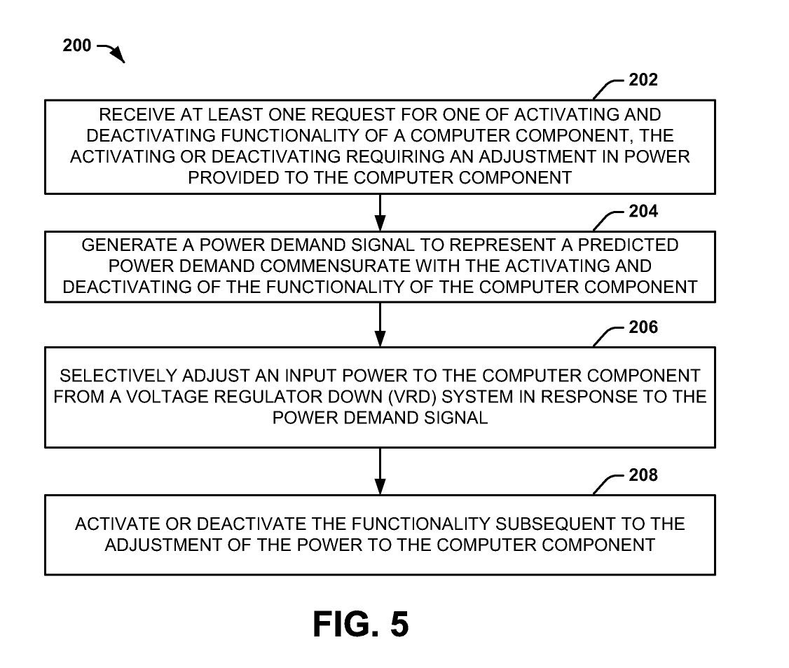

In view of the foregoing structural and functional features described above, an example method will be better appreciated with reference to FIG. 5. While, for purposes of simplicity of explanation, the method of FIG. 5 is shown and described as executing serially, it is to be understood and appreciated that the method is not limited by the illustrated order, as parts of the method could occur in different orders and/or concurrently from that shown and described herein.

FIG. 5 illustrates an example of a method 200 for controlling power efficiency in a computer system. At 202, at least one request for one of activating and deactivating functionality of a computer component is received, the activating or deactivating requiring an adjustment in power provided to a computer component (e.g., computer component 12 of FIG. 1). At 204, a power demand signal is generated (e.g., by the power demand logic 20 of FIG. 1) to represent a predicted power demand commensurate with the activating and deactivating of the functionality of the computer component. For instance, the power demand signal can be a multi-level analog voltage or a digital signal having a duty cycle adjusted according to a predicted demand, such as described herein.

At 206, an input power to the computer component from a voltage regulator down (VRD) system (e.g., VRD system 14 of FIG. 1) is selectively adjusted in response to the power demand signal (e.g., through activating or deactivating power phases 18 of FIG. 1). At 208, functionality of the computer component is modified (e.g., activated or deactivated) subsequent to the adjustment of the power to the computer component.

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first.” or “another” element, or the equivalent thereof, it should be interpreted to include one or more than one such element, neither requiring nor excluding two or more such elements.

What is claimed is:

1. A system (10) comprising:
power demand logic (20) to generate a power demand signal corresponding to a predicted power demand determined for an associated computer component (12); and
a voltage regulator down (VRD) system (14) comprising at least one power phase (18), the VRD system (14) to selectively adjust an input power to the computer component (12) based on power efficiency in response to the power demand signal.

2. The system of claim 1, wherein the power demand logic (20) is to adjust a magnitude of the power demand signal commensurate with a change in the power demand prior to the computer component (12) one of activating and deactivating functionality (16) that requires adjustment in the input power provided to the computer component (12).

3. The system of claim 1, wherein the power demand signal comprises one of an analog signal having a magnitude corresponding to the power demand and a digital signal having a duty-cycle corresponding to the power demand.

4. The system of claim 1, wherein the at least one power phase (18) comprises a plurality of power phases (18), and wherein the VRD system (14) is to selectively enable and disable at least a portion of the plurality of power phases (18) to provide the input power to the computer component (12) based on the power efficiency in response to the power demand signal.

5. The system of claim 1, wherein the at least one power phase (18) comprises a single power phase (18), and wherein the VRD system (14) is to modulate a switching frequency of the single power phase (18) based on the power demand signal.

6. The system of claim 1,
wherein the computer component (12) comprises at least one of a processor (152) comprising a plurality of processor cores (166), a memory system (154) comprising a plurality of memory modules (170) and memory controllers, and an input/output (I/O) system (156) comprising a plurality of I/O modules (174), and
wherein the VRD system (14) comprises a respective at least one VRD system (158, 160, 162), the power demand for each of the at least one VRD system (158, 160, 162) being determined based on activation and deactivation of the respective at least one of the plurality of processor cores (166), the plurality of memory modules (170) and memory controllers, and the plurality of I/O modules (174).

7. The system of claim 1, wherein the power demand logic (20) is to adjust a measurable characteristic associated with the power demand signal in response to at least one request to one of activating and deactivating functionality (16) associated with the computer component (12), the one of activating and deactivating the functionality (16) associated with the computer component (12) occurring in response to the at least one request subsequent to the adjustment of the measurable characteristic.

8. A method (200) for controlling power efficiency in a computer system, the method comprising:
receiving at least one request for one of activating and deactivating functionality (16) of a computer component (12), the activating or deactivating requiring an adjustment in power provided to a computer component (12);
generating a power demand signal to represent a predicted power demand commensurate with the activating and deactivating of the functionality (16) of the computer component (12);
selectively adjusting an input power to the computer component (12) from a voltage regulator down (VRD) system (14) in response to the power demand signal; and
one of activating and deactivating the functionality (16) subsequent to the adjustment of the power to the computer component (12).

9. The method of claim 8, wherein generating the power demand signal further comprises one of adjusting a magnitude of an analog power demand signal and adjusting a duty-cycle of a digital power demand signal, the duty cycle corresponding to the predicted power demand.

10. The method of claim 8, wherein selectively adjusting the input power to the computer component (12) comprises selectively enabling and disabling a plurality of power phases (18) of the VRD system (14) in response to the power demand signal.

11. The method of claim 8, wherein selectively adjusting the input power to the computer component (12) comprises modulating a switching frequency of a power phase (18) of the VRD system (14) based on the power demand signal.

12. A computer power management system (10) comprising:
a memory system (154) comprising a plurality of memory modules (170), the memory system (154) to selectively control activation and deactivation of the plurality of memory modules (170) in response to at least one request for activation and deactivation;
memory power demand logic (168) to adjust a measurable characteristic of a power demand signal corresponding to a change in power demand predicted for the memory system (154) in response to the at least one request for activation and deactivation and based on power efficiency; and
a memory voltage regulator down (VRD) system (160) comprising a plurality of power phases (178), the memory VRD system (160) to selectively enable and disable the plurality of power phases (178) to provide power to the memory system (154) in response to the power demand signal prior to the activation and deactivation of the plurality of memory modules (170).

13. The system of claim 12, further comprising:
processor power demand logic (164) associated with a processor system (152), the processor power demand logic (164) to adjust a measurable characteristic of a processor power demand signal corresponding to a change in power demand predicted for the processor system (152) in response to at least one request for selective activation and deactivation of a plurality of cores (166) and based on power efficiency; and
a processor VRD system (158) comprising a plurality of processor power phases (176), the processor VRD system (158) to selectively enable and disable the plurality of processor power phases (176) to provide power to the processor system (152) in response to the processor power demand signal.

14. The system of claim 12, further comprising:
input/output (I/O) power demand logic (172) associated with an ID system (156), the I/O power demand logic (172) to adjust a measurable characteristic of an I/O power demand signal corresponding to a change in power demand associated with the I/O system (156) in response to at least one request for selective activation and deactivation of a plurality of I/O modules (174) and based on power efficiency; and
an I/O VRD system (162) comprising a plurality of I/O power phases (180), the I/O VRD system (162) to selectively enable and disable the plurality of I/O power phases (180) to provide power to the I/O system (156) in response to the I/O power demand signal.

15. The system of claim 12, further comprising a single conductor between the power demand logic and the memory VRD system (160) for communication of the power demand signal to the memory VRD system (160), the power demand signal comprising one of an analog signal having a magnitude corresponding to the power demand and a digital signal having a duty-cycle corresponding to the power demand.
